(19) United States
(12) Patent Application Publication
(10) Pub. No.: US 2023/0040848 A1
(43) Pub. Date: Feb. 9, 2023

(54) METHOD OF PRODUCING SKIN-COVERED PRODUCT

(71) Applicant: Japan Plastics Technologies Co., Ltd., Aichi (JP)

(72) Inventors: Michikazu SHIMA, Aichi (JP); Mamoru YOKOYAMA, Aichi (JP)

(73) Assignee: Japan Plastics Technologies Co., Ltd., Aichi (JP)

(21) Appl. No.: 17/788,896

(22) PCT Filed: Dec. 16, 2020
(86) PCT No.: PCT/JP2020/046975

§ 371 Date: Jun. 24, 2022

(30) Foreign Application Priority Data
Dec. 26, 2019 (JP) 2019-236827

(51) Int. Cl. B29D 99/00; B32B 1/00; B32B 27/08; B32B 21/08

(52) U.S. Cl. CPC B29D 99/001; B32B 1/00; B32B 27/08; B32B 21/08; B29L 2031/3041

(57) ABSTRACT

Provided is a method of producing a skin-covered product in which a skin is bonded to a base material, the method capable of performing a roll treatment by a robot to improve work efficiency and quality, and reducing the number of production steps for producing the skin-covered product by immediately performing a rolling step after trimming the bonded skin by vacuum molding.

The method of producing a skin-covered product in which the skin is bonded to the base material according to the present invention includes (1) an integration step of integrating the base material and the skin by vacuum molding while drawing the skin to the base material such that the skin is rolled on a back surface side, (2) a skin trimming step of cutting an extra portion around the skin rolled on a back side in accordance with a form of the base material, and (3) a rolled portion welding step of moving the skin, rolled by a horn tip of an ultrasonic welding machine manually or by a robot, to a skin end portion while sliding the skin on the back surface side of the base material, and then ultrasonically welding the base material and the skin by ultrasonic welding.

### TECHNICAL FIELD

The present invention relates to a method of producing a skin-covered product in which a skin is bonded to a base material formed of plastic, wood, or another hard member.

### BACKGROUND ART

Conventionally, in the case of producing a skin-covered product in which a skin having a sewing pattern is bonded to plastic, wood, or the like, the skin-covered product has been produced by the following steps.

First, the skin to be bonded is molded by vacuum molding and the like so as to be compatible with a form of a base material to be attached. After an unnecessary portion of an outer periphery of the molded skin is cut (trimmed), if necessary, a decorative sewing pattern is manually sewn to the skin to prepare the skin to which the sewing pattern is applied. On the other hand, an adhesive is applied onto a surface of the base material in order to bond the skin, and dried. Then, the skin is bonded to the base material by pressure bonding, and the skin protruding from the base material is subject to roll treatment and is completed.

In such a conventional method of producing a skin-covered product, since the rolling is performed by a human hand, there are many defects in a roll treatment step, and many defective products are generated by the roll treatment step. There are many variations in rolling for each product, and there is also a problem that it is difficult to maintain a constant quality. Since bonding in the rolling is performed with the adhesive, an adhesive application step and a drying step are required, and therefore, there is a problem that it takes time until the roll treatment is performed.

### SUMMARY OF INVENTION

### Technical Problems

Accordingly, the present invention has been made to solve the above-described problems, and an object of the present invention is to provide a method of producing a skin-covered product in which a skin is bonded to a base material, the method capable of performing a roll treatment by a robot to improve work efficiency and quality, and reducing the number of production steps for producing the skin-covered product by immediately performing a rolling step after trimming the bonded skin by vacuum molding (hereinafter, this method is also referred to as a “method of producing a skin-covered product”).

### Solutions to Problems

In order to solve the above problems, the present invention employs the following means. A method of producing a skin-covered product in which a skin is bonded to a base material, according to the present invention is a method of producing a skin-covered product having the skin attached to the base material, this method including:

(1) an integration step of integrating the base material and the skin by vacuum molding while drawing the skin to the base material so that the skin is rolled on a back surface side;

(2) a skin trimming step of cutting an extra portion around the skin rolled on a back side in accordance with a form of the base material; and

(3) a rolled portion welding step of moving the skin, rolled by a horn tip of an ultrasonic welding machine manually or by a robot, to a skin end portion while sliding the skin on the back surface side of the base material, and then ultrasonically welding the base material and the skin by ultrasonic welding.

According to the method of producing a skin-covered product according to the present invention, the skin around the base material is shaped so as to be rolled on the back surface side of the base material by molding the skin so as to roll the skin on the back surface side of the base material during vacuum molding. Thus, the base material and the skin can be integrated by the rolled skin. The end of the rolled skin can be fixed in a state where the skin is rolled around the back surface of the base material by sliding and welding the skin with the ultrasonic welding machine manually or by the robot.

The method of producing a skin-covered product according to the present invention is a method of producing a skin-covered product having a skin attached to a base material, this method including:

(1) an adhesive application step of applying an adhesive to the base material;

(2) an integration step of integrating the base material and the skin by vacuum molding while drawing the skin to the base material so that the skin is rolled on a back surface side;

(3) a skin trimming step of cutting an extra portion around the skin rolled on a back side in accordance with a form of the base material; and

(4) a rolled portion welding step of moving the skin, rolled by a horn tip of an ultrasonic welding machine manually or by a robot, to a skin end portion while sliding the skin on the back surface side of the base material, and then ultrasonically welding the base material and the skin by ultrasonic welding.

According to the method of producing a skin-covered product according to the present invention, the skin around the base material is shaped so as to be rolled on the back surface side of the base material by molding the skin so as to roll the skin on the back surface side of the base material during vacuum molding, and the base material and the skin can be bonded with the adhesive. Thus, the end of the rolled skin can be fixed by reliably rolling the skin around the back surface of the base material by sliding and welding the skin with the ultrasonic welding machine manually or by the robot. In the skin-covered product according to the present invention, since the back surface side is shaped so as to be already rolled on the back surface side of the base material without applying an adhesive, the skin is stably rolled on the back surface side; however, by bonding the back surface of the base material and the skin with the adhesive, the base material and the skin can be reliably fixed by a bonding step.

In addition, in the method of producing a skin-covered product according to the present invention, the integration step may be characterized in that vacuum molding is performed using a mold slightly smaller than an outer periphery of the base material with respect to the base material.

By performing vacuum molding using the mold slightly smaller than the outer periphery of the base material during vacuum molding, the skin can be easily molded so as to be rolled around the base material.

A skin-covered product according to the present invention is a skin-covered product including a base material and a skin covered with the base material, in which the skin is shaped in a form in which the skin is rolled by vacuum molding at an end of the base material.

The skin-covered product according to the present invention can be a skin-covered product in which the base material and the skin are already integrated in a product after vacuum molding because the end of the base material is creased in the rolling by vacuum molding.

In the skin-covered product according to the present invention, it may be characterized that the base material has no recess on a skin side, and the skin side of the base material and the skin are not bonded.

Since the skin-covered product according to the present invention is already integrated with a product obtained after vacuum molding of the base material and the skin, it is possible to obtain a product in which the base material and the skin are integrated without being bonded with an adhesive.

### BRIEF DESCRIPTION OF DRAWINGS

FIG. 1 is a cross-sectional view of a skin-covered product 100 according to a first embodiment.

FIG. 2 is a process chart showing a method of producing the skin-covered product 100 according to the first embodiment.

FIG. 3 is an explanatory view showing a part of an integration step of the first embodiment.

FIG. 4 is an explanatory view showing a part of the integration step of the first embodiment.

FIG. 5 is an explanatory view showing a part of a skin trimming step of the first embodiment.

FIG. 6 is an explanatory view showing a part of a rolled portion welding step of the first embodiment.

FIG. 7 is a cross-sectional view of a skin-covered product 100 according to a second embodiment.

FIG. 8 is a process chart showing a method of producing the skin-covered product 100 according to the second embodiment.

### DESCRIPTION OF EMBODIMENTS

Hereinafter, a method of producing a skin-covered product 100 in which a skin 20 is bonded to a base material 10 according to an embodiment will be described in detail with reference to the drawings. The embodiments and drawings described below illustrate some of the embodiments of the present invention, are not used for the purpose of limiting to these configurations, and can be appropriately changed without departing from the gist of the present invention. In the drawings, corresponding components are denoted by the same or similar reference numerals.

### First Embodiment

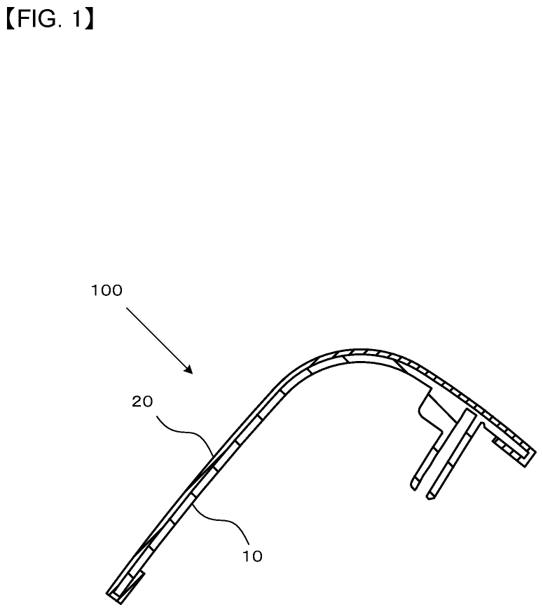

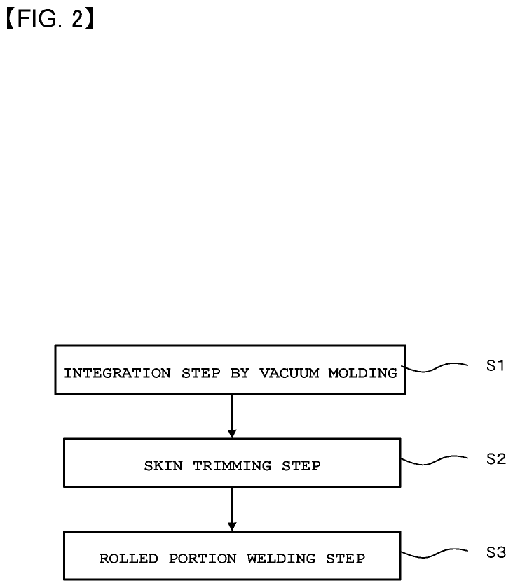

As shown in FIG. 1, the method of producing the skin-covered product 100 according to the first embodiment is a method for producing the skin-covered product 100 in which the skin 20 is bonded to a surface of the base material 10 such as plastic or wood by vacuum molding. As shown in FIG. 2, the method of producing the skin-covered product 100 mainly includes an integration step (S1) of integrating the skin 20 with the base material 10 by vacuum molding, a skin trimming step (S2) of cutting a periphery of the skin 20 in accordance with a form of the base material 10, and a rolled portion welding step (S3) of rolling the skin 20 after the skin trimming step. Hereinafter, each step will be described in detail.

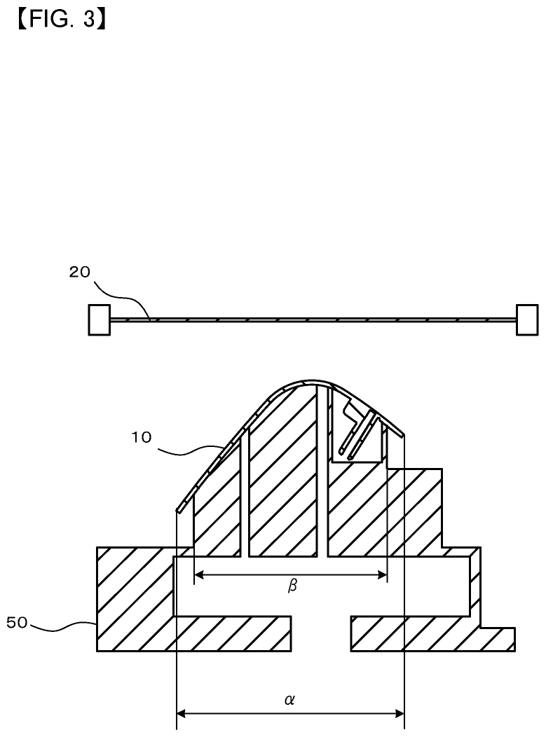

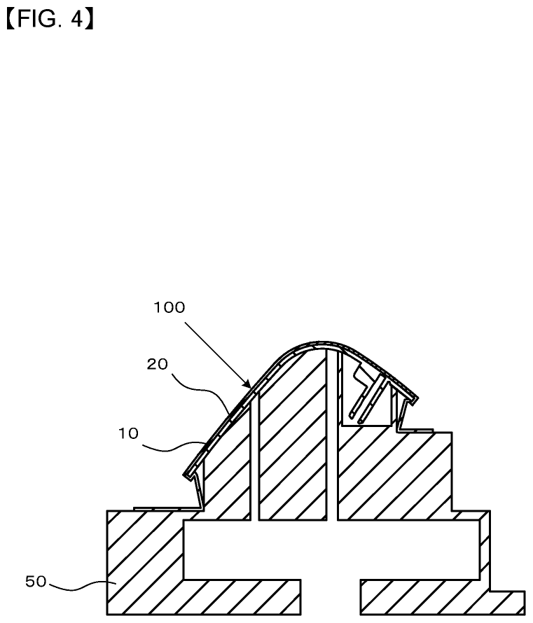

The integration step (S1) is a step of integrating the skin 20 with the base material 10, and in the present invention, a step of molding the skin 20 and the step of integrating the skin 20 and the base material 10 are simultaneously performed by vacuum molding. As the base material 10 used in the first embodiment, it is preferable to use a material which is a hard member such as plastic or wood, has a surface on which the skin 20 is disposed is formed of a flat surface or a convex surface, and has no concave surface. The skin 20 is not particularly limited as long as it is a material that can be used for vacuum molding. Examples thereof include olefin-based thermoplastic elastomers, PVC leather, and thermoplastic polyurethane. A surface of the skin may be decorated by leather processing, embossing, or another processing. As shown in FIGS. 3 and 4, vacuum molding is performed using a mold 50 for vacuum molding having an area β slightly smaller than an outer periphery a of the base material 10. First, the base material 10 is set in the mold 50 thus configured, and the skin 20 is disposed on a bonding surface side of the base material 10, and is heated by a heater (not shown) (FIG. 3). As a result, the skin 20 becomes flexible and easily follows a curved surface of the surface of the base material 10. Then, the skin 20 is drawn by evacuating a back surface side of the base material 10, and the skin 20 is integrated with the surface of the base material 10 while being molded into a form of the base material 10 (FIG. 4). At this time, since an outer periphery of the mold 50 is formed slightly smaller than the base material 10, the skin is molded so as to be rolled on the back surface side of the base material 10 as shown in FIG. 4. Then, by releasing the mold after cooling, the skin 20 is molded into the form of the base material 10, shaping is performed in the state where the skin 20 is rolled on back surface side of the base material 10, and the skin 20 is integrated with the base material 10 by supporting the base material 10 by the rolled portion. In this manner, the base material and the skin can be integrated without using an adhesive. In the present invention, by simultaneously performing the step of molding the skin 20 and the step of bonding the base material 10 and the skin 20 in one step, it is possible to reduce the number of steps by two as compared with a case where the step of molding the skin 20 and the step of bonding the base material 10 and the skin 20 are separately performed as in a conventional method of producing the skin-covered product 100. Thus, a production speed can be increased, and the cost can be reduced.

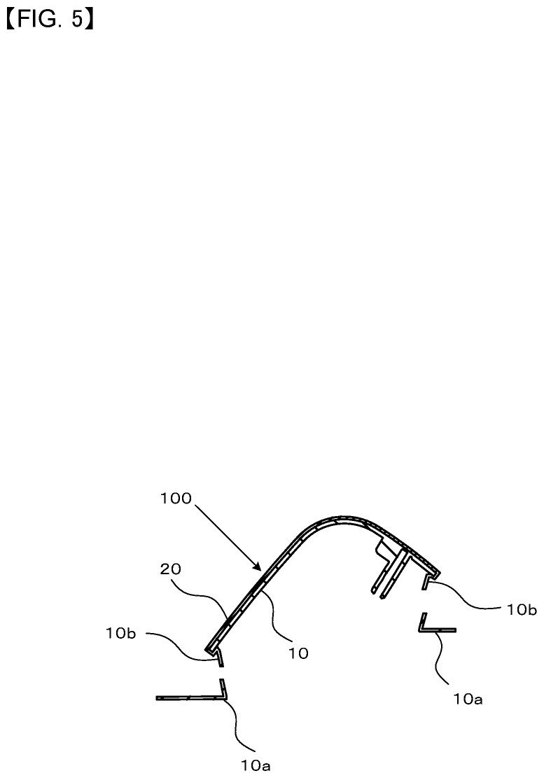

As shown in FIG. 5, the skin trimming step (S2) is a step of cutting an extra portion 10a of the skin 20 bonded to the base material 10. The skin trimming step may be performed by machining. The skin may be cut while leaving a rolled portion 10b of about more than 0 mm and 15 mm or less with respect to the outer periphery of the base material 10.

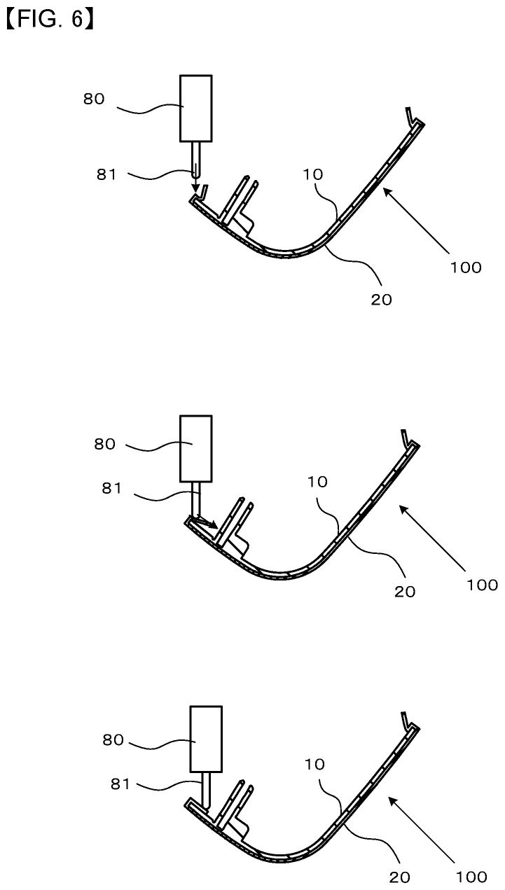

The rolled portion welding step (S3) is a step of rolling and fixing the skin 20, protruding around the base material 10, on the back side. As shown in FIG. 6A, the rolled portion welding step (S3) may be performed manually; however, a robot cylinder-type ultrasonic welding machine 80 may be used. By abutting a tip of a horn 81 of the ultrasonic welding machine 80 against the end of the base material 10, the rolled skin 20 can be pressed against the base material 10 as shown in FIG. 6A. From this state, as shown in FIG. 6B, the horn 81 of the ultrasonic welding machine 80 is moved to the end of the skin 20 or the vicinity of the end of the skin 20 so as to slide on the base material 10. As a result, since the skin 20 is originally shaped in a state where the periphery thereof is rolled around the base material 10, it is possible to bring the skin 20 into a state of being in close contact with the base material 10. Then, as shown in FIG. 6C, the base material 10 and the skin 20 are ultrasonically welded to bond the ends of the base material 10 and the skin 20. In such a rolled portion welding step, the base material 10 and the skin 20 are bonded at predetermined intervals along the outer periphery, and the entire periphery of the skin 20 can be fixed in a state of being rolled. The number and interval of sites to be ultrasonically welded can be appropriately selected according to the product. As the robot type ultrasonic welding machine 80, a three-or-more-axis industrial robot or a two-axis+one-axis robot having two axes on the welding machine side and one axis at a base material installation portion may be used.

As described above, the rolling step can be automatically performed by the robot as compared with the case of manually rolling and fixing with an adhesive as in the related art, so that the work speed can be increased as compared with the related art, and quality of a rolled product can be improved.

Thus, the skin-covered product 100 is completed. Since the skin-covered product 100 produced in this way is shaped in a shape in which the skin 20 is rolled with respect to the outer periphery of the base material 10, the rolled portion of the outer periphery of the base material 10 is very clear, and the skin-covered product 100 having excellent aesthetic appearance of the end of the base material as compared with the related art can be obtained. Since the skin 20 is shaped into the shape rolled with respect to the outer periphery of the base material 10, rolling can be performed by using a three-axis industrial robot in which it has been conventionally difficult to perform rolling. In addition, by using the industrial robot, the work speed can be increased, and the quality of the rolled product can be improved.

As the skin-covered product 100, automobile related parts such as a door trim, an armrest, an ornament, and a console lid, furniture such as a chair and a desk, and the like can be considered; however, the present invention is not limited thereto, and any product may be used as long as the product functions as a product to which the skin is bonded.

### Second Embodiment

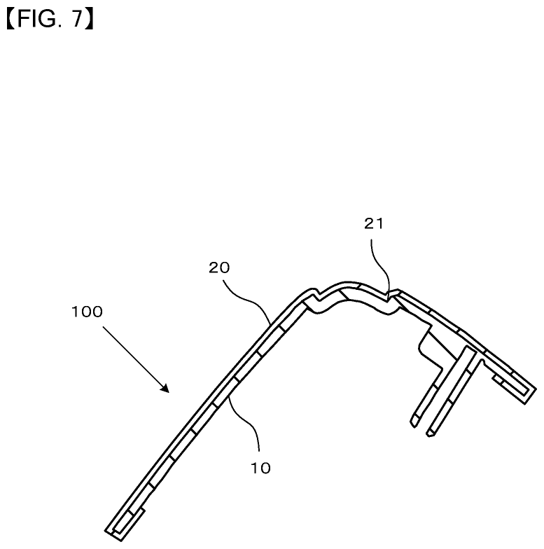

A method of producing a skin-covered product 100 according to a second embodiment will be described. The skin-covered product 100 according to the second embodiment is shown in FIG. 7. The skin-covered product in the second embodiment has a concave surface 21 formed in a concave shape on a surface to which a skin is bonded.

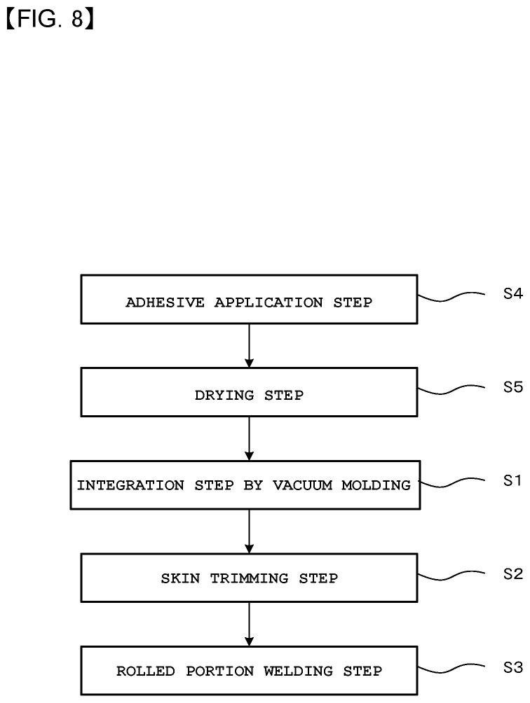

As shown in FIG. 8, the method of producing the skin-covered product 100 according to the second embodiment further includes an adhesive application step (S4) of applying an adhesive to a base material 10 and a drying step (S5) of drying the adhesive before the integration step (S1) by vacuum molding according to the first embodiment. The integration step (S1) by vacuum molding, a skin trimming step (S2), and a rolled portion welding step (S3) are the same as those in the first embodiment, and thus the description thereof is omitted.

The adhesive application step (S4) is a step of applying an adhesive for bonding a skin 20 to a surface of the base material 10. As the base material 10 on a side to which the skin 20 is bonded, plastic molded into a predetermined form by vacuum molding, injection molding, or the like, molded wood, or the like is usually used, and the material thereof is not limited thereto. The adhesive is applied to the surface of the base material molded into a form of a necessary part. In the present specification and claims, the adhesive includes all those that bond the base material and the skin by adhesion or pressure-sensitive adhesion, and examples thereof include a chloroprene rubber-based adhesive, hot melt, and the like.

The drying step (S5) is a step of drying the adhesive applied to the surface of the base material 10. The adhesive is left to stand for a suitable time depending on the type of the adhesive and dried. In the case of an adhesive that does not need to be dried, this step may be omitted.

Thereafter, as in the first embodiment, the skin-covered product 100 is completed through the integration step (S1) by vacuum molding, the skin trimming step (S2), and the rolled portion welding step (S3).

In the skin-covered product 100 according to the second embodiment, since the base material 10 and the skin 20 are bonded with the adhesive, the base material 10 and the skin 20 can be bonded and integrated even if the concave surface 21 formed in a concave shape is formed on the surface side of the base material 10 to which the skin 20 is bonded.

In the embodiment described above, the adhesive is not applied to the back surface side of the base material 10; however, the adhesive may also be applied to an end on the back surface side of the base material 10 or the vicinity of the end. By adopting such a configuration, since the skin rolled in the bonding step is bonded on the back surface side, welding by the rolled portion welding step can be easily performed.

The present invention is not limited to the above-described embodiments at all, and it goes without saying that the present invention can be implemented in various modes as long as it falls within the technical scope of the present invention.

### INDUSTRIAL APPLICABILITY

As shown in the above-described embodiments, the present invention can be industrially used as a method of producing an automobile related component.

### REFERENCE SIGNS LIST

10 Base material
10a Extra portion
10b Rolled portion
20 Skin
21 Concave surface
50 Mold
80 Ultrasonic welding machine
81 Horn
100 Skin-covered product

1. A method of producing a skin-covered product having a skin attached to a base material, the method of producing a skin-covered product comprising:
integrating the base material and the skin by vacuum molding while drawing the skin to the base material in such a way that the skin is rolled on a back surface side;
skin trimming by cutting an extra portion around the skin rolled on a back side in accordance with a form of the base material; and
rolled portion welding by moving the skin, rolled by a horn tip of an ultrasonic welding machine manually or by a robot, to a skin end portion while sliding the skin on the back surface side of the base material, and then ultrasonically welding the base material and the skin by ultrasonic welding.

2. A method of producing a skin-covered product having a skin attached to a base material, the method of producing a skin-covered product comprising:
applying an adhesive to the base material;
integrating the base material and the skin by vacuum molding while drawing the skin to the base material in such a way that the skin is rolled on a back surface side;
skin trimming by cutting an extra portion around the skin rolled on a back side in accordance with a form of the base material; and
rolled portion welding by moving the skin, rolled by a horn tip of an ultrasonic welding machine manually or by a robot, to a skin end portion while sliding the skin on the back surface side of the base material, and then ultrasonically welding the base material and the skin by ultrasonic welding.

3. The method of producing a skin-covered product according to claim 1, wherein in the integrating, vacuum molding is performed using a mold slightly smaller than an outer periphery of the base material.

4. A skin-covered product comprising:
a base material; and
a skin covered with the base material,
wherein the skin is shaped in a form in which the skin is rolled by vacuum molding at an end of the base material.

5. The skin-covered product according to claim 4, wherein the base material has no recess on a skin side, and the skin side of the base material and the skin are not bonded.

6. The method of producing a skin-covered product according to claim 2, wherein in the integrating, vacuum molding is performed using a mold slightly smaller than an outer periphery of the base material.
